(19) United States
(12) Patent Application Publication
(10) Pub. No.: US 2009/0280824 A1
(43) Pub. Date: Nov. 12, 2009

(54) GEO-TAGGING OBJECTS WITH WIRELESS POSITIONING INFORMATION

(75) Inventor: Terhi Tuulikki Rautiainen, Vantaa (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/116,699

(22) Filed: May 7, 2008

(51) Int. Cl. H04Q 7/20

(52) U.S. Cl. 455/456.1

(57) ABSTRACT

A method, apparatus, system, and computer program product are disclosed for identifying the geographic location where an object is created in a mobile wireless device, based on the known locations of a plurality of wireless access points. When the object is stored by the mobile device in a media object file format, the mobile wireless device determines the current location with respect to a plurality of wireless access points having known geographic locations. This enables identifying the geographic location of the wireless device at the time the object is created and then associating the location information with the object as a geo-tag, which can be attached to the object at the time it is created or later.

### FIELD

The embodiments relate to identifying the geographic location of events such as photographs or other objects by a mobile wireless device, based on the known locations of wireless access points.

### BACKGROUND

A typical GPS receiver calculates its position using the accurately timed radio signals from four or more GPS satellites. GPS signals are adversely affected by multipath delay of the GPS radio signals when they are reflected off surrounding terrain; buildings, canyon walls, urban streets, hard ground, etc. Moreover, because GPS signals have a very low power level when they reach the Earth's surface, they are almost completely attenuated inside buildings.

An example scenario where this becomes a problem is when photographing museum objects on display in several cities, such as when the photographer is touring on vacation. At the end of the tour, after having taken many photographs, the photographer will be unsure of the location of some of the objects, not having kept a detailed record of every object photographed. Even if the camera had a GPS sensor, that would have been of no avail within the buildings housing the museums, where GPS signals would have been distorted or attenuated.

What is needed is a way to perform geo-tagging of objects created by mobile wireless devices that are either not equipped with GPS sensors or that are used in locations where GPS signals are adversely affected by multipath delay or are attenuated inside buildings.

### SUMMARY

A method, apparatus, system, and computer program product are disclosed for identifying the geographic location where photographs or other objects are created by a mobile wireless device, based on the known locations of a plurality of wireless access points. In example embodiments, the mobile wireless device includes a digital camera for taking photographs. When the shutter button of the digital camera is actuated and a digital image or object is captured by the camera and stored in a digital image file, the control module of the mobile wireless device determines the current location of the device with respect to a plurality of wireless access points having known geographic locations. In example embodiments, the digital image or object can be post-processed to determine what the location of the device was with respect to the plurality of wireless access points.

In example embodiments, the method can perform the step of determining a current location for the wireless device, for example, by analyzing received signals from each of the plurality of access points, to obtain a distance value from the wireless device to each of the plurality of access points. The method can then calculate a relative position of the wireless device with respect to the plurality of access points. The method can then access absolute or estimated positioning information, such as geographic coordinates, of each of the plurality of wireless access point devices and combine the relative position of the wireless device with the absolute or estimated positioning information of the plurality to obtain an absolute or estimated position of the wireless device, such as its own geographic coordinates.

The relative positioning method may perform a calculation, for example, based on signal strengths, wherein distances are related to the respective signal strengths. The relative positioning method may also perform triangulation based on the direction of the signal. The relative positioning method may also perform triangulation based on both direction and signal strength. Other relative positioning methods can include a proximity algorithm or other deterministic algorithms. The relative positioning method may be by pattern recognition of the received signals, matching the received pattern with stored patterns that are associated with known geographic locations, in a technique known as “fingerprinting”.

The location information can include geographic coordinates and names of places and things near the device's current location. The location information may be stored in the digital image file of the device as embedded metadata along with the stored digital image or other object, geo-tagging the photograph. The geo-tagged photographs may then be displayed on the user's device or wirelessly transmitted by the device. The embodiments are especially useful for geo-tagging photographs taken indoors or nearby tall buildings where GPS signals are distorted or not available.

In embodiments, the location information may be stored in a file separate from, but associated with, the stored digital image or other object in the digital image file of the device and the geo-tagging of the photograph may be performed later. In embodiments, the geo-tagging of the photograph may be performed off-line, when the user uploads the digital images of the photographs and the location information to a personal computer or to a server, for example on the Internet for creating a web album.

In embodiments, the digital image or object and the location information may be stored in a variety of media, for example a random access memory (RAM), a programmable read only memory (PROM), a magnetic recording medium such as a video tape, an optical recording medium such as a writeable CDROM or DVD.

### DESCRIPTION OF THE FIGURES

FIG. 1A illustrates an external view and a functional block diagram of an example embodiment of the mobile wireless device equipped with a digital camera module and a wireless access point network.

FIG. 1B illustrates a functional block diagram of an example embodiment of the mobile wireless device of FIG. 1A, showing the digital camera module in more detail, and further showing two wireless transceivers.

FIG. 2A is a flow diagram of an example embodiment a process of the mobile wireless device in geo-tagging a digital image of a photograph with the geographic location of the device when it took the photograph.

FIG. 2B shows a modification of the flow diagram of FIG. 2A, for example where the photographer anticipates taking a photograph at a particular location and sets up the camera prior to taking the photograph.

FIGS. 3A and 3B are example functional block diagrams of the random access memory (RAM) of the mobile wireless device storing the geographic location of the device when it took the photograph, based on the known geographic coordinates of a plurality of access points.

FIG. 4 is an example functional block diagram of the random access memory (RAM) of the mobile wireless device storing the geographic location of the device when it took the photograph, based on “fingerprint” pattern matching of signals from a plurality of access points.

FIG. 5 is an example functional block diagram of the random access memory (RAM) of the mobile wireless device storing the geographic location information as embedded metadata in association with the digital image of the photograph in the digital image file of the device.

FIG. 6 illustrates a functional block diagram of an example embodiment of the mobile wireless device uploading the geographic location metadata and the digital image of the photograph via a wireless access point and the Internet, to a web album server.

FIG. 7 is an example functional block diagram of the random access memory (RAM) of the mobile wireless device storing a sequence digital images taken by the camera as a moving picture, with the geographic location information of a plurality of the digital images being embedded as metadata in association with the corresponding digital image in a plurality of digital image files. The digital camera module records the motion pictures by periodically capturing the sequence of digital images, for example at thirty images per second, and the controller 20 can further process the sequence as compressed JPEG files or Moving Picture Experts Group (MPEG) files or in another format and store them in the RAM 62.

### DISCUSSION OF EXAMPLE EMBODIMENTS OF THE INVENTION

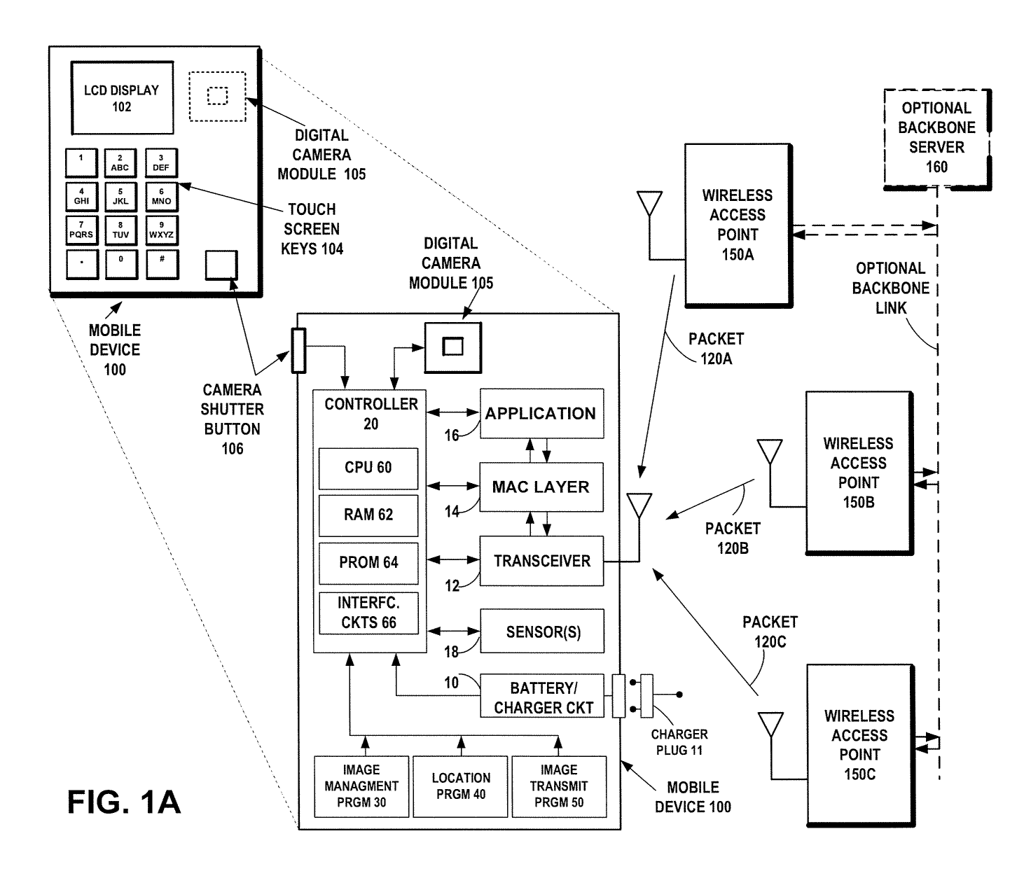

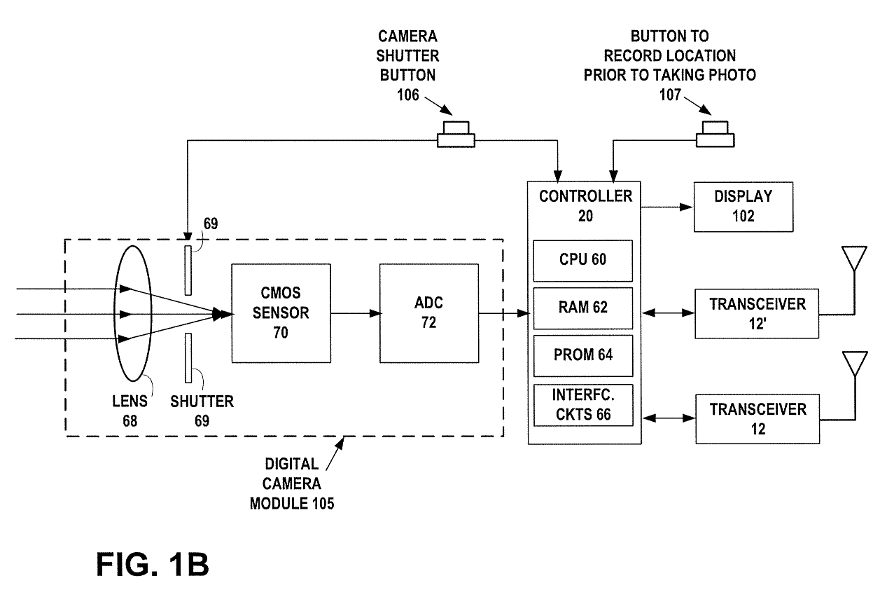

FIG. 1A illustrates an external view and a functional block diagram of an example embodiment of the mobile wireless device 100 equipped with a digital camera module 105 and a network of wireless access points 150A, 150B, and 150C. The mobile wireless device 100 can be a mobile communications device, personal digital assistant (PDA), cell phone, pager, laptop computer, or palmtop computer, or the like. The mobile wireless device 100 can also be an integrated component of a vehicle, such as an automobile, bicycle, airplane or other mobile conveyance. FIG. 1B illustrates a functional block diagram of an example embodiment of the mobile wireless device 100 of FIG. 1A, showing the digital camera module 105 in more detail, the display 102, and further showing two wireless transceivers 12 and 12′. The transceivers are transceivers that include both a transmitter and a receiver operating using the wireless network protocol. Transceiver 12 may operate using a wireless wide area network (WWAN) protocol operating, for example, under a cellular telephone network protocol, and transceiver 12′ may operate using a wireless local area network (WLAN) protocol or a wireless personal area network (WPAN) protocol.

The mobile wireless device 100 includes the digital camera module 105, which includes a lens 68, an electric shutter 69, a CMOS sensor 70, and an analog to digital converter (ADC) 72. The lens 68 converges incident light on the CMOS sensor 70. The electric shutter 69 may be an electromechanical or electro-optical shutter that is opaque to the incident light until actuated by the shutter button 106. The CMOS sensor 70 may be an RGB color filter that converts incident light into electric signals representing red, green, and blue light components. Images are captured by actuating the shutter button 106 to open the electric shutter 69, which exposes the CMOS sensor 70 to incident light refracted through the lens 68. The electric signals representing red, green, and blue light output by the CMOS sensor 70 are converted to digital image or object signals by the analog to digital converter 72 and output to the controller 20. The image sensor 70 may comprise a different type of sensor, such as a charge coupled device (CCD). The digital camera module 105 may be mounted anywhere on the device 100, for example on the front side of the device 100 or connected to the device 100 via a cable or via a Bluetooth or other wireless personal area network (WPAN) link.

The controller 20 can further process the digital image or object signals from the analog to digital converter 72, forming a digital image file by compressing the digital image using the Joint Photographic Experts Group (JPEG) compression algorithm or other compression algorithms and performing other image processing operations on the image file before storing the image file in the RAM 62. The digital camera module 105 may also record motion pictures by periodically capturing a sequence of digital images, for example at thirty images per second, and the controller 20 can further process the sequence as compressed JPEG files or Moving Picture Experts Group (MPEG) files or in another format and store them in the RAM 62.

The mobile wireless device 100 and the wireless access points 150A, 150B, and 150C communicate in a wireless network that can be a wireless personal area network (WPAN) operating, for example, under the Bluetooth or IEEE 802.15 network protocol. The wireless network can be a wireless local area network (WLAN) operating, for example under the IEEE 802.11, Hiperlan, WiMedia Ultra Wide Band (UWB), WiMax, WiFi, or Digital Enhanced Cordless Telecommunications (DECT) network protocol. Or, the wireless network can be a wireless wide area network (WWAN) operating, for example, under a cellular telephone network protocol, for example Global System for Mobile (GSM), General Packet Radio Service (GPRS), Enhanced Data rates for GSM Evolution (EDGE), Code Division Multiple Access (CDMA), Universal Mobile Telecommunications System (UMTS) and CDMA2000. The respective wireless network protocols include provision for communication by the mobile wireless device 100 in the network with the wireless access points 150A, 150B, and 150C by means of the respective protocol data unit (PDU) packets 120A, 120B, and 120C. These examples of wireless network protocols for the device 100 are not meant to be limiting, since it is common for wireless communications protocols to provide for communication between mobile wireless devices and a wired network infrastructure via wireless access points.

Each of these example networks is defined by its respective communications protocol to include the exchange of packets of data and control information between the wireless access point and the mobile wireless devices. Each of the communications protocols defines levels of networking functions and the services performed at each level for the wireless access points and the mobile wireless devices operating using the protocol. Typically, the networking functions include the transmission of packets by the access point having the purpose of announcing its presence to mobile wireless devices within range, either by initiating an inquiry or beacon packet or by responding with a response packet to a probe packet from a mobile device.

The mobile wireless device 100 includes a control module 20, which includes a central processing unit (CPU) 60, a random access memory (RAM) 62, a read only memory (ROM) or programmable read only memory (PROM) 64, and interface circuits 66 to interface with the key pad 104, liquid crystal display (LCD) 102, and the digital camera module 105. The device 100 may optionally include a microphone, speakers, ear pieces, a video camera, or other imaging devices, etc. The RAM 62 and PROM 64 can be removable memory devices such as smart cards, Subscriber Identity Modules (SIMs), Wireless Application Protocol Identity Modules (WIMs), semiconductor memories such as a RAM, ROM, or PROM, flash memory devices, etc. The Medium Access Control (MAC) Layer 14 of the network protocol of the wireless device and/or application program 16 can be embodied as program logic stored in the RAM 62 and/or PROM 64 in the form of sequences of programmed instructions which can be executed in the CPU 60, to carry out the functions of the disclosed embodiments. The program logic can be delivered to the writeable RAM, PROM, flash memory device, etc. 62 of the device 100 from a computer program product or article of manufacture in the form of computer-usable media such as resident memory devices, smart cards or other removable memory devices, or in the form of program logic transmitted over any transmitting medium which transmits such a program. Alternately, the MAC Layer 14 and/or application program 16 can be embodied as integrated circuit logic in the form of programmed logic arrays or custom designed application specific integrated circuits (ASIC). The transceiver 12 in device 100 operates in accordance with the network protocol of the wireless device.

The image management program 30 in device 100 enables the controller 20 to process the digital image signals forming a digital image file by compressing the digital image using the JPEG compression algorithm or other compression algorithms and enables the controller to perform other image processing operations on the image file and stores the image file in the RAM 62. The image management program 30 also enables the controller 20 to process sequences of digital images in a moving picture as compressed JPEG files or MPEG files or another format and stores them in the RAM 62. The image management program 30 can be embodied as program logic stored in the RAM 62 and/or PROM 64 in the form of sequences of programmed instructions which can be executed in the CPU 60, carry out the functions of the disclosed embodiments.

The location program 40 in device 100 enables the controller 20 to determine a current relative position of the device 100 with respect to the plurality of wireless access point devices 150A, 150B, and 150C. The location program 40 can calculate relative positions of the device 100 based on received signal strengths, triangulation based on the direction of the received signal, triangulation based on both direction and signal strength of received signals, and other relative positioning methods such as proximity algorithms or other deterministic algorithms. The location program 40 can calculate relative positions of the device 100 based on pattern recognition of the received signals, matching the received pattern with stored patterns that are associated with known geographic locations, in a technique known as “fingerprinting”. Pattern data is collected on an access points observed at a location and this pattern data is later processed to find a match with a corresponding reference pattern for that location out of many possible reference patterns for locations. The location program 40 can be embodied as program logic stored in the RAM 62 and/or PROM 64 in the form of sequences of programmed instructions which can be executed in the CPU 60, carry out the functions of the disclosed embodiments.

The image transmit program 50 in device 100 enables the controller 20 to upload the geographic location metadata and the associated digital image of a photograph and wirelessly transmit them to other mobile wireless devices or to a wireless access point, for example access point 150A, for applications such as geo-tagging the photograph in a web album server on the Internet. The image transmit program 50 can be embodied as program logic stored in the RAM 62 and/or PROM 64 in the form of sequences of programmed instructions which can be executed in the CPU 60, carry out the functions of the disclosed embodiments.

Different meta data format types can be used for geo tagging. Example embodiments for the positional meta data can include:
Exchangeable Image File Format, EXIF;
International Press Telecommunications Council, IPTC, standard;
Extensible Metadata Platform, XMP;
NewsML;
Universal Transverse Mercator Projection, UTM;
National Grid; or
Irish Grid.

Other components that may be included in the mobile wireless device 100 of FIG. 1A include sensors 18, which can detect changes in the inertial frame of reference of the device 100, to enable damping vibrations that might impair the quality of the photographs taken by the digital camera module 105. The battery charging circuit 10 and charger plug 11 can replenish the charge in rechargeable batteries used by the device 100.

The mobile wireless device 100 of FIG. 1B my optionally have two or more wireless transceivers 12 and 12′. One of the transceivers 12 can be, for example, a cellular telephone transceiver operating under example network protocols such as GSM, GPRS, EDGE, CDMA, UMTS or CDMA2000. The second transceiver 12′ can be, for example, a wireless LAN transceiver operating under example network protocols such as IEEE 802.11, Hiperlan, WiMedia UWB, WiMax, WiFi, or DECT. Optionally, a third transceiver (not shown) can be included in the device 100, operating under a personal area network protocol such as the Bluetooth or IEEE 802.15 protocol.

FIG. 1A further illustrates an optional backbone network for the access points 150A, 150B, and 150C. The access points 150A, 150B, and 150C may be mobile or fixed and each can know its own geographic location. If an access point is mobile, it can know its own geographic location when it is currently stationary, for example, by receiving packets from other access points with known geographic locations. Alternately, a mobile access point may know its own geographic location by means of a Global Positioning System (GPS) sensor. If the access points 150A, 150B, and 150C are fixed, they may be optionally connected over the backbone link of FIG. 1A to the backbone server 160. The optional server 160 can maintain a database of geographic coordinate location data, which represents the absolute or estimated position for each of the access points 150A, 150B, and 150C.

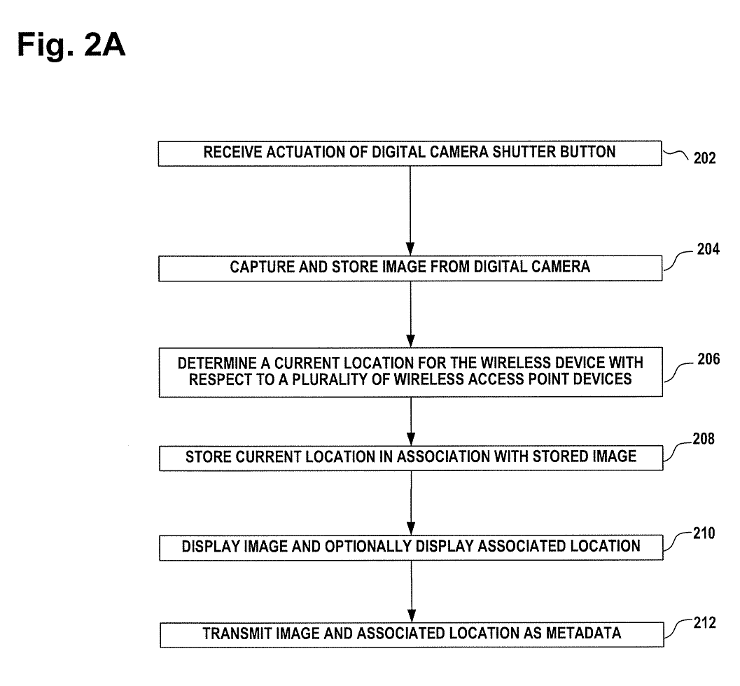

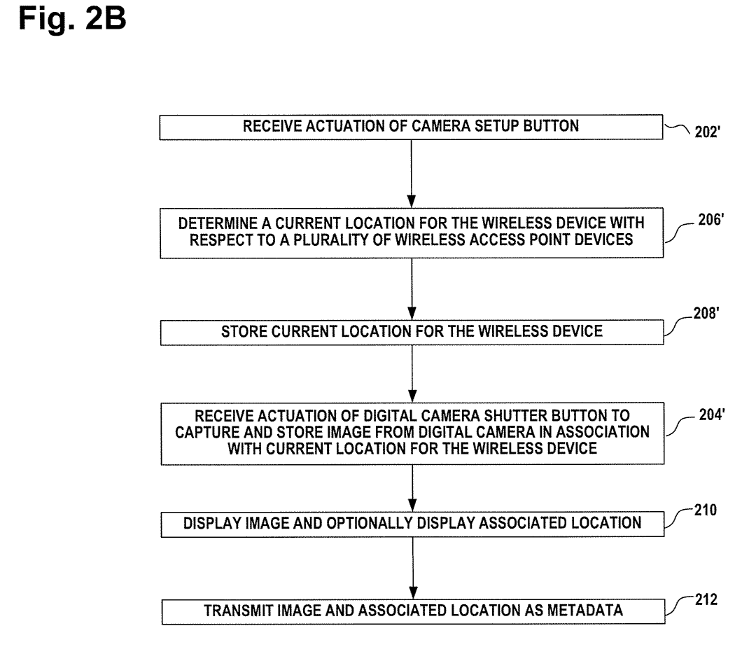

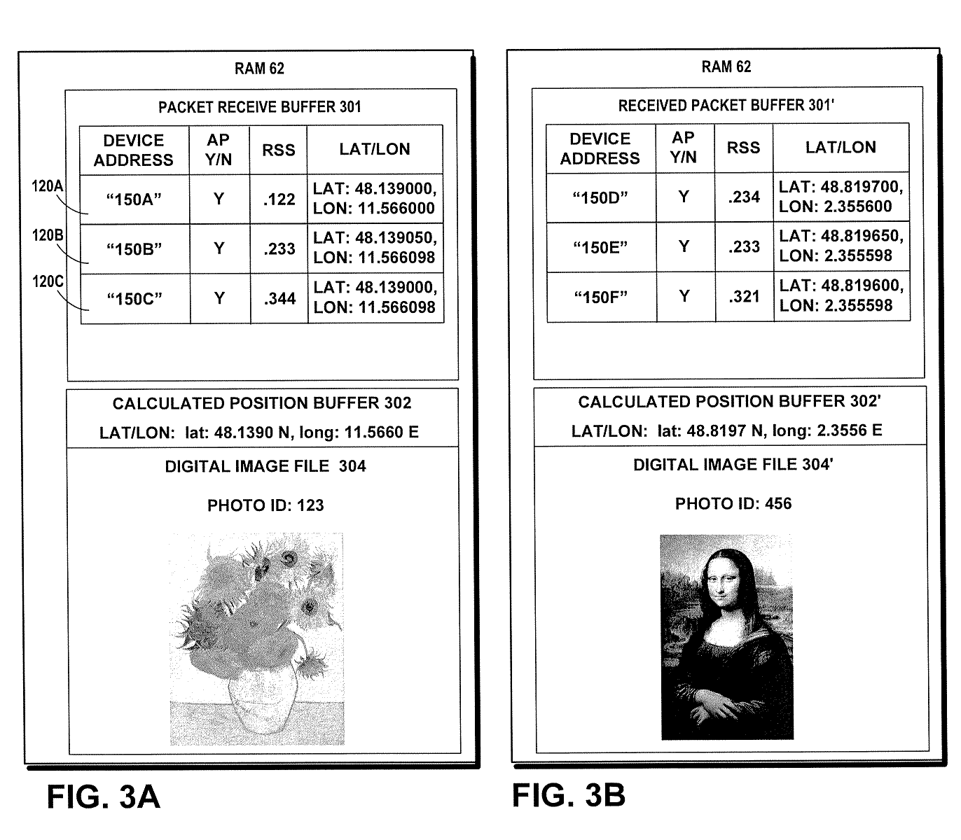

FIG. 2A is a flow diagram of an example embodiment a process of the mobile wireless device in geo-tagging a digital image of a photograph with the geographic location of the device when it took the photograph. In step 202, when the shutter button 106 of the digital camera module 105 is actuated, step 204 captures an image with the digital camera module 105. The image management program 30 is executed by the CPU 60 in the controller 20 to process the captured digital image signals, forming a digital image file 304, which it stores in the RAM 62 of FIG. 3A.

In the example of FIG. 3A, the user is exploring a museum, such as Neue Pinakothek in Munich. The Munich museum has a network of wireless access point devices 150A, 150B, and 150C arranged at various points of interest. The user has stopped near a point of interest, the still life by Vincent van Gogh, “Sunflowers”, and has taken a photograph 123 with the camera 105 in the user's device 100.

Step 206 determines the current location for the mobile wireless device 100 with respect to a plurality of wireless access points 150A, 150B, and 150C. The location program 40 is executed by the CPU 60 in the controller 20 to calculate relative positions of the device 100 with respect to the wireless access points 150A, 150B, and 150C based on received signal strengths (RSS), triangulation based on the direction of the received signal, triangulation based on both direction and signal strength of received signals, or other relative positioning methods such as proximity algorithms or other deterministic algorithms. The location program 40 then accesses absolute or estimated positioning information, such as the geographic coordinates, of each of the plurality of wireless access point devices 150A, 150B, and 150C. The geographic coordinates of each of the plurality of wireless access point devices 150A, 150B, and 150C can be stored in a database accessible by the mobile device 100. The absolute or estimated location information can include geographic coordinates and names of places and things near the device's current location. The location program 40 then combines the relative position of the wireless device 100 with the absolute or estimated positioning information of the plurality of access points 150A, 150B, and 150C to obtain a calculated absolute or estimated position of the wireless device 100, such as its own geographic coordinates.

Alternately, the absolute or estimated location information for the access points can be provided in the packets 120A, 120B, and 120C sent by the wireless access points 150A, 150B, and 150C to the mobile device 100. These packets are buffered in the packet receive buffer 301 in the RAM 62 of FIG. 3A, which shows the latitude and longitude of each of the access points. In FIG. 3A, packet 120A is stored in the packet receive buffer 301 of the RAM 62, with a field designating the device address “150A”, a field designating that the sending device 150A is an access point “Y”, and a field providing the latitude and longitude of the sending device 150A. Packets 120B and 120C are also stored in the packet receive buffer 301 of the RAM 62 with fields providing the latitude and longitude of the sending devices 150B and 150C, respectively. Other data can be stored in the packet receive buffer 301 of the RAM 62, for example the received signal strength (RSS), which can be used to calculate relative positions of the device 100 with respect to the wireless access points 150A, 150B, and 150C.

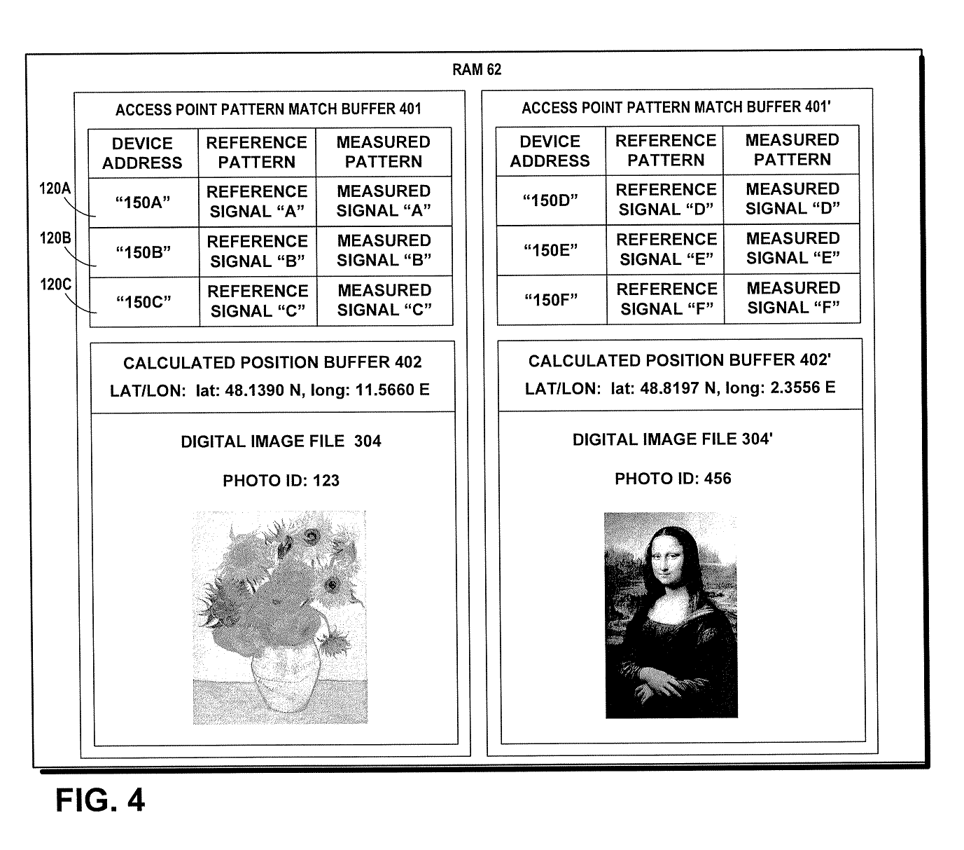

The location program 40 can alternately calculate relative positions of the device 100 with the fingerprinting technique of pattern recognition of the received signals from the access points, matching the received pattern with stored patterns that are associated with known geographic locations. FIG. 4 shows an example of an access point pattern match buffer 401 in the RAM 62, in which the “fingerprint” technique compares the pattern of signals currently received from the access points by device 100 with a reference map of multiple patterns of received signals previously stored in a database. An example pattern is stored in the buffer 401 in the form of the respective sending device address value of packets 120A, 120B, and 120C received by the device 100 and the corresponding reference signal patterns. The currently measured signal patterns of the respective sending devices are also stored in the buffer 401. Then the reference signal patterns and measured signal patterns are compared. There will be many patterns of received signals previously stored in the buffer 401. The best match of the currently measured pattern with a particular stored pattern will be selected and the corresponding geographic location on the reference map is considered to be the calculated absolute or estimated position of the device 100.

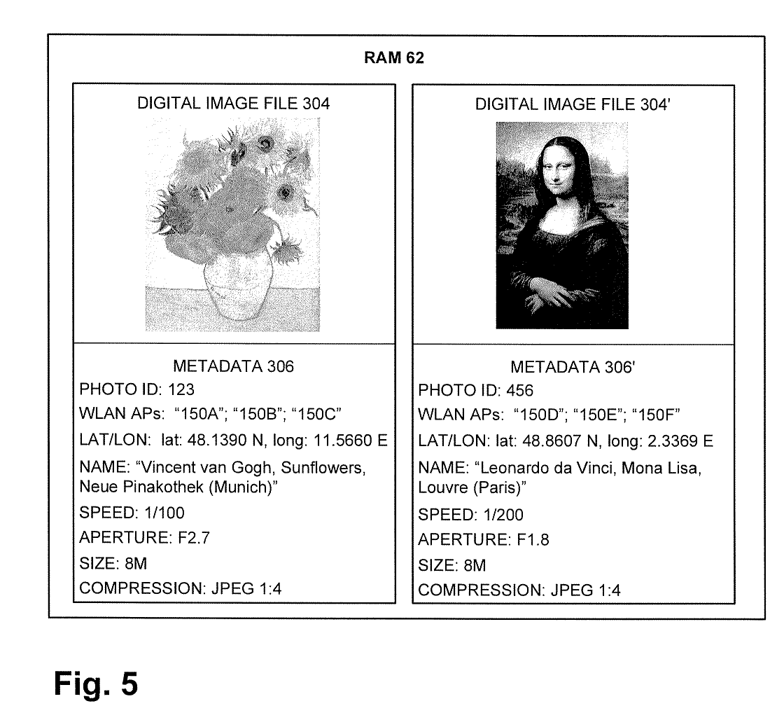

In Step 208, the location program 40 stores the calculated absolute or estimated position of the device 100 as metadata in the calculated position buffer 302 of the RAM 62 of FIG. 3A, which is the latitude and longitude of the device 100. The calculated absolute or estimated position of the device 100 may be stored in the digital image file 304 as embedded metadata 306 along with the stored digital image, thereby geo-tagging the photograph, as shown in FIG. 5. The names of places and things near the device's current location, along with the geographic coordinates of the device 100, can be stored in the digital image file 304 of FIG. 5.

In Step 210, the geo-tagged photographs may optionally be displayed on the display 102 of the device 100 and the calculated absolute or estimated position of the device 100 can be optionally displayed along with the photograph. The photo can also be placed on a map based on the location coordinates attached to it.

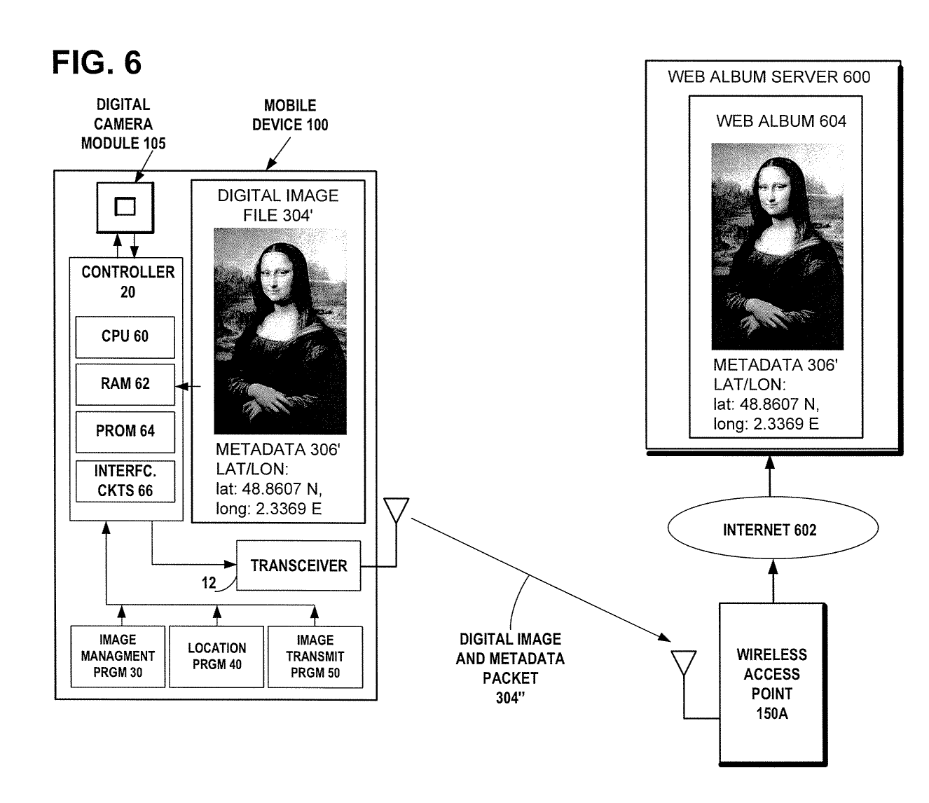

In Step 212, the image transmit program 50 is executed in the CPU 60 of the controller 20 to upload the calculated absolute or estimated position metadata of the device 100 and the associated digital image of a photograph and wirelessly transmit them to other mobile wireless devices or to a wireless access point, for example access point 150A, for applications such as geo-tagging the photograph in a web album server on the Internet. FIG. 6 shows the mobile wireless device 100 uploading the calculated absolute or estimated position metadata of the device 100 and the digital image of the photograph as the packet 304″ via the wireless access point 150A and the Internet 602, to a web album server 600, for the purpose of compiling a web album 604, thereby geo-tagging the photograph at the server 600.

FIG. 2B shows a modification of the flow diagram of FIG. 2A, where steps 206′ and 208′ occur before step 204′, for example where the photographer anticipates taking a photograph at a particular location and sets up the camera prior to taking the picture. In step 202′, pressing the setup button 107 on the mobile wireless device 100 of FIG. 1B, separate from the shutter button 106, activates step 206′ and the location program 40 to determine the current location for the mobile wireless device 100 with respect to a plurality of wireless access points 150A, 150B, and 150C. In step 208′, the location program 40 stores the calculated absolute or estimated position of the device 100 as metadata in the calculated position buffer 302 of the RAM 62 of FIG. 3A. Then later in step 204′, when the shutter button 106 is activated and the photograph is taken at that location, the image management program 30 is executed to process the captured digital image signals, forming a digital image file 304, which it stores in the RAM 62 of FIG. 3A.

In embodiments, the calculated absolute or estimated position of the device 100 or the signal patterns measured by the device 100 may be stored in a file separate from, but associated with, the stored digital image of the photograph, in the digital image file of the device. The geographical location determination and/or geo-tagging of the photograph may be performed later. In embodiments, the geo-tagging of the photograph may be performed off-line, when the user uploads the digital image of the photograph and the calculated absolute or estimated position of the device 100 or the signal patterns measured by the device 100, to a personal computer or to a server 600 on the Internet 602, such as for creating a web album.

In embodiments, the digital image and the location information may be stored in a variety of media, for example a random access memory (RAM), a programmable read only memory (PROM), a magnetic recording medium such as a video tape, an optical recording medium such as a writeable CDROM or DVD.

In example embodiments, the method can perform the step of determining the current location for the wireless device 100 with respect to the plurality of wireless access points 150A, 150B, and 150C, for example, by analyzing received signals from each of the plurality of access points, to obtain a relative distance value of the wireless device 100 from each of the plurality of access points 150A, 150B, and 150C. The location program 40 determines a current relative position of the device 100 with respect to the plurality of wireless access point devices 150A, 150B, and 150C.

In embodiments, the location program 40 can then access absolute or estimated positioning information, such as the geographic coordinates, of each of the plurality of wireless access point devices 150A, 150B, and 150C. The geographic coordinates of each of the plurality of wireless access point devices 150A, 150B, and 150C can be stored in a database in the mobile device 100 or can be provided in the signals sent by the wireless access points 150A, 150B, and 150C to the mobile device 100. For example, FIG. 1A shows the wireless access point 150A sending packet 120A to the mobile wireless device 100. FIG. 3A shows packet 120A stored in the packet receive buffer 301 of the RAM 62, with a field designating the device address “150A”, a field designating that the sending device 150A is an access point “Y”, and a field providing the latitude and longitude of the sending device 150A. FIG. 3A shows packet 120B sent from access point 150B and packet 120C sent from access point 150C with similar fields and data. The location program 40 in the mobile device 100 can combine the latitude and longitude values provided in the respective packets 120A, 120B, and 120C of the access points 150A, 150B, and 150C with the relative positions calculated for the device 100 with respect to the respective access points 150A, 150B, and 150C, to compute the absolute or estimated location of the device 100, expressed, for example, in its latitude and longitude.

The geographic coordinates of each of the plurality of wireless access point devices 150A, 150B, and 150C can alternately be provided to the device 100 in removable memory devices such as smart cards, SIMs, WIMs, or semiconductor memories such as a RAM, ROM, or PROM.

An example relative positioning method may determine the relative position of the device 100 based on received signal strengths of signals received by device 100 from each of the wireless access point devices 150A, 150B, and 150C, wherein distances are related to the radio frequency power loss between each respective access point and the device 100. The positioning method may also use round trip time and time of flight measurement techniques. The location program 40 can execute a triangulation algorithm to estimate the location of the device 100 to be at the intersection of circles with their centers at each respective wireless access point device 150A, 150B, and 150C, the radius of the respective circle being determined by the respective received signal strength, round trip time, or time of flight measurement.

Another example relative positioning method may determine the relative position of the device 100 based on the time of arrival or time difference of arrival of a reference signal from the device 100 to each of the wireless access point devices 150A, 150B, and 150C. The difference in the time of arrival of the same reference signal at the three wireless access point devices 150A, 150B, and 150C can be used to calculate the relative position of the device 100 with respect to the access point devices. The location program 40 can execute a triangulation algorithm to estimate the location of the device 100 to be at the intersection of circles with their centers at each respective wireless access point device 150A, 150B, and 150C, the radius of the respective circle being determined by the respective times of arrival of the reference signal.

Another example relative positioning method may determine the relative position of the device 100 based on the angle of arrival of a reference signal from the device 100 to each of the wireless access point devices 150A, 150B, and 150C. The difference in the angle of arrival of the reference signal at the three wireless access point devices 150A, 150B, and 150C can be used to calculate the relative position of the device 100 with respect to the access point devices. Another example location measurement technique is measuring the angle of arrival at the user's mobile wireless device 100, if the device 100 is equipped with multiple antennas. The location program 40 can execute a triangulation algorithm to estimate the location of the device 100 to be at the intersection of lines of position with respect to each respective wireless access point device 150A, 150B, and 150C, the line of position being determined by the respective angle of receipt of the reference signal. The positioning method may also perform triangulation based on both angle of arrival and signal strength techniques.

Another example relative positioning method may determine the relative position of the device 100 based on comparing the pattern of signals currently received by device 100 with a map of multiple patterns of received signals previously stored in a database or downloaded from a central server, a technique known as “fingerprinting”. The location program 40 can match the currently received pattern of signals from wireless access point devices 150A, 150B, and 150C with stored patterns in the database, which can be used to calculate the relative position of the device 100 with respect to the access point devices. The stored patterns in the database can also be provided to the device 100 in removable memory devices such as smart cards, SIMs, WIMs, or semiconductor memories such as a RAM, ROM, or PROM. In another example embodiment, the currently measured pattern from a particular location can be uploaded from the user's mobile wireless device 100 to a central server for computation of the position, which can then be downloaded to the user's mobile wireless device 100 and attached to the digital image.

FIG. 4 shows an example of an access point pattern match buffer 401 in the RAM 62, which can be used in the “fingerprint” technique of comparing the pattern of signals currently received by device 100 with a map of multiple patterns of received signals previously stored in a database. An example pattern is stored in the buffer 401 in the form of the respective sending device address value of packets 120A, 120B, and 120C received by the device 100 and the corresponding reference signal patterns of the respective sending devices. The currently measured signal patterns of the respective sending devices are received. Then the reference and measured signal patterns are compared for the differences between the corresponding reference and measured values. There will be many patterns of received signals previously stored in the buffer 401. If the result for a particular stored pattern is less than a predetermined threshold value, then the device 100 is estimated to be located near the corresponding calculated position value stored in the buffer 402 in association with the particular stored pattern and the digital image stored in digital image file 304.

In the example of FIG. 4, the user is exploring a museum, such as Neue Pinakothek in Munich. The Munich museum has a network of wireless access point devices 150A, 150B, and 150C arranged at various points of interest. The user has stopped near a point of interest, the still life by Vincent van Gogh, “Sunflowers”, and has taken a photograph 123 with the camera 105 in the user's device 100. Device 100 then proceeds to determine its current position by the “fingerprint” technique. It calculates its location as the calculated position shown in the buffer 402 of FIG. 4, and the corresponding digital image stored in buffer 304 in association with the calculated position in buffer 402, thereby geo-tagging the digital image for its location in Munich. The corresponding digital image and calculated position stored in buffers 304 and 402 are then displayed to the user on the display 102 of the device 100. The device 100 may also transmit the photograph and the geo-tag to other mobile wireless devices in range.

In the examples shown in FIG. 3B and FIG. 4, the user has explored a second museum, such as the Louvre in Paris. The Paris museum has a network of wireless access point devices 150D, 150E, and 150F arranged at various points of interest. The user has stopped near a second point of interest, the portrait by Leonardo da Vinci, “Mona Lisa”, and has taken a second photograph 456 with the camera 105 in the user's device 100. Device 100 then proceeds to determine its current position in Paris by the “fingerprint” technique. It calculates its location as the calculated position shown in the buffer 402 of FIG. 4, and the corresponding digital image stored in buffer 304 in association with the calculated position in buffer 402, thereby geo-tagging the digital image for its location in Paris.

The wireless access point devices 150A, 150B, and 150C of FIG. 1 need not be connected to an infrastructure network, and yet they can know their geographic location. If an access point is not connected to an infrastructure network, the unconnected access point it may know its geographic location from using, for example, its own copy of the location program 40. The location program 40 determines the current relative location of the unconnected access point with respect to the plurality of other wireless access point devices, for example, by analyzing received signals from each of the plurality of other wireless access point devices, to obtain a relative distance value from the unconnected access point to each of the plurality of other wireless access point devices and then calculating a relative position of the unconnected access point with respect to the plurality of other access point devices. The positioning method may be by “triangulation” based on signal strengths, wherein distances are proportional to the signal strength. The positioning method may also be by triangulation based on direction of the signal or triangulation based on direction and signal strength. Other positioning methods can include a proximity algorithm or other deterministic algorithms.

After determining the relative position of the wireless device 100, the location program 40 then accesses from each access point the absolute or estimated positioning information, such as geographic coordinates, of each of the plurality of wireless access point devices 150A, 150B, and 150C and combines the calculated relative position of the wireless device 100 with the absolute or estimated positioning information of the plurality 150A, 150B, and 150C to obtain an absolute or estimated position of the wireless device 100, such as its own geographic coordinates.

FIG. 5 shows the RAM 62 of the mobile wireless device 100 storing the geographic location information as embedded metadata in association with the digital image or object in a first file 304 for the first photograph 123 taken in Munich and in a second file 304′ for the second photograph 456 taken in Paris. The metadata embedded with each digital image includes the photo ID, the identities of the access points that were used to establish the geographic location where the photo was taken, the name of the object photographed, and various camera settings when the photo was taken, such as the speed, aperture, memory size occupied, and compression data. If the mobile wireless device 100 is equipped with magnetometers and motion sensors, more detailed positioning information can be added to the digital image, such as the direction towards which the camera was pointing at the time of the photograph was taken.

In FIG. 5 the position information of the metadata section could, in some embodiments, be replaced by raw radio environment measurement data, for example, received signal strengths (RSS) from different access points. Since in calculating the true location latitude and longitude, calculating the information is not typically a very time-critical operation to be done immediately, the position calculation can be done later at more suitable time (to save the battery, for example), e.g. when the mobile wireless device 100 is charging, put to silent/meeting mode, or at night time. Then the raw measurement data in metadata section is replaced by true latitude and longitude coordinates or other position information data. Moreover, the off-line location processing from radio environment measurement data actually allows the location program 40 in FIG. 1, to be located outside the mobile wireless device 100. If the raw measurement data is attached to the digital image, the actual positioning calculation can be made for example on the server hosting the web album, and no latitude and longitude positioning computation and related databases are needed in the mobile wireless device 100.

FIG. 6 shows the mobile wireless device uploading the geographic location metadata and the digital image of the photograph 123 via a wireless access point and the Internet, to a web album server. The mobile wireless device 100 is uploading the calculated absolute or estimated position metadata of the device 100 and the digital image of the photograph 123 as the packet 304″ via the wireless access point 150A and the Internet 602, to a web album server 600, for the purpose of compiling a web album 604, thereby geo-tagging the photograph 123 at the server 600.

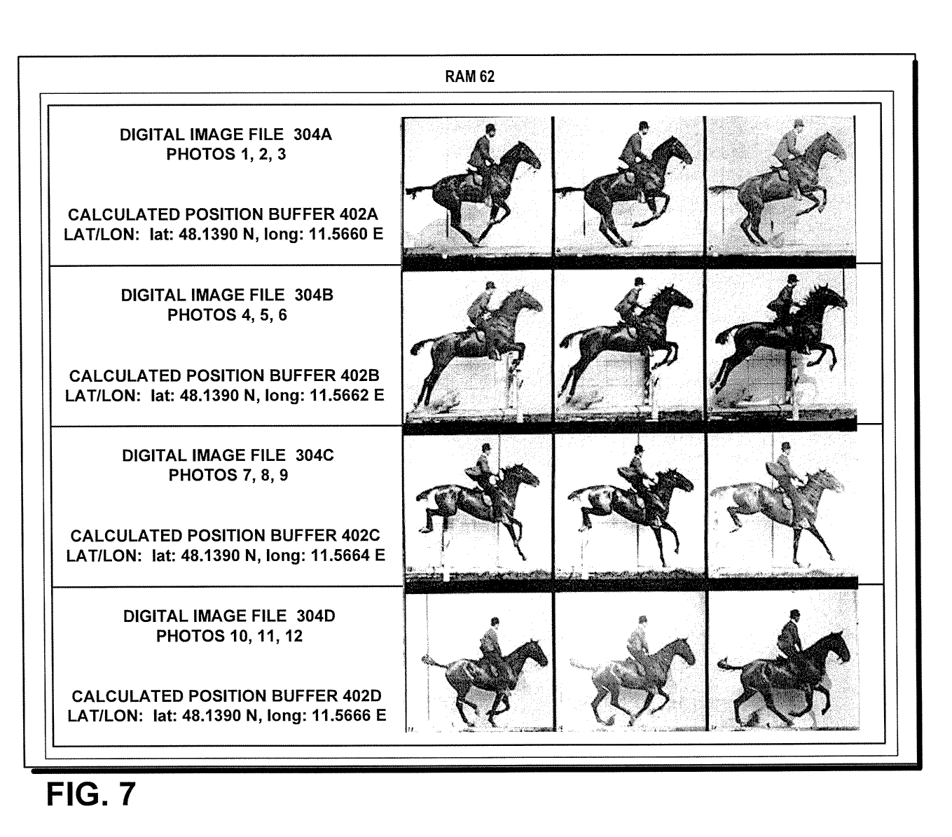

FIG. 7 is an example functional block diagram of the RAM 62 of the mobile wireless device 100 storing a sequence digital images of photographs 1 through 12, taken by the digital camera module 105 as a moving picture, with the geographic location information of each of a plurality of the digital images being stored in the calculated position buffers 402A, 402B, 402C, 402D, embedded as metadata in association with the corresponding digital image in a plurality of respective digital image files 304A, 304B, 304C, 304D. The digital camera module 105 records the motion pictures by periodically capturing the sequence of digital images of photographs 1 through 12, for example at thirty images per second, and the controller 20 can further process the sequence as compressed JPEG files or Moving Picture Experts Group (MPEG) files or in another format and store them in the RAM 62. In the example of FIG. 7, every third digital image is geo-tagged with the calculated absolute or estimated position of the wireless device 100 with respect to the geographic coordinates of each of the plurality of wireless access point devices 150A, 150B, and 150C, where the corresponding digital image is captured.

The above discussion has been directed to digital photography. Other example embodiments may use the same method to geo-tag other objects such as short message service (SMS) messages, multimedia messages, or other phone messages. For example, when a recipient receives a phone call or SMS message, he/she immediately sees the geo-tag identifying from where the call or message originates. The SMS or phone message can be sent from the caller's mobile wireless device 100 with the caller's radio environment measurement data attached to it as metadata, and while the SMS or phone message is being routed over the network to the recipient, the caller's geographic location is determined in a network server hosting a location program 40 and related positioning databases. Alternatively, positioning can be determined on the user's or the recipient's mobile wireless device 100. Also, for example, personal notes stored in mobile wireless device 100 can be geo-tagged in the same fashion.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than WiMedia networks.

What is claimed is:

1. A method, comprising:
creating an object with a mobile wireless device; and
determining a location of the mobile wireless device with respect to a plurality of wireless access points substantially when said creating occurs.

2. The method of claim 1, where said determining step occurs after said creating step.

3. The method of claim 1, where said determining step occurs before said creating step.

4. The method of claim 1, further comprising:
said determining step including analyzing received signals from the plurality of access points to obtain a distance value from the wireless device to one or more of the plurality of access points.

5. The method of claim 1, further comprising:
said determining step including calculating a relative position of the wireless device with respect to the plurality of access points.

6. The method of claim 1, further comprising:
said determining step including accessing estimated positioning information of the plurality of wireless access point devices and combining a relative position of the wireless device with the estimated positioning information of the plurality to obtain an estimated position of the wireless device.

7. The method of claim 1, further comprising:
said determining step including performing a calculation based on distance determination measurements from said access points.

8. The method of claim 1, further comprising:
said determining step including performing triangulation based on direction of receiving signals from said access points.

9. The method of claim 1, further comprising:
said determining step including performing triangulation based on both direction and distance determination of signals received from said access points.

10. The method of claim 1, further comprising:
said determining step including performing pattern recognition of received signals from said access points by comparing the received pattern with stored patterns associated with known locations.

11. The method of claim 1, further comprising:
storing said location determined for the mobile wireless device in association with said created object.

12. The method of claim 1, further comprising:
storing said location determined for the mobile wireless device as metadata embedded in said created object.

13. The method of claim 1, further comprising:
displaying said location determined for the mobile wireless device in association with displaying said created object.

14. The method of claim 1, further comprising:
storing said location determined for the mobile wireless device separately from, but associated with said created object; and
embedding at a later time said location determined for the mobile wireless device as metadata embedded in said created object.

15. The method of claim 1, further comprising:
transmitting to a destination said location determined for the mobile wireless device separately from said created object; and
embedding at said destination said location determined for the mobile wireless device as metadata embedded in said created object.

16. The method of claim 1, further comprising:
said mobile wireless device using a wireless protocol drawn from the group consisting of Bluetooth, IEEE 802.15, IEEE 802.11, Hiperlan, WiMedia Ultra Wide Band (UWB), WiMax, WiFi, Digital Enhanced Cordless Telecommunications (DECT), Global System for Mobile (GSM), General Packet Radio Service (GPRS), Enhanced Data rates for GSM Evolution (EDGE), Code Division Multiple Access (CDMA), Universal Mobile Telecommunications System (UMTS) and CDMA2000.

17. The method of claim 1, further comprising:
said mobile wireless device being a device drawn from the group consisting of a PDA, cell phone, pager, laptop computer, and palmtop computer.

18. The method of claim 1, further comprising:
said created an object representing a still photograph.

19. The method of claim 1, further comprising:
said created an object representing a moving picture sequence.

20. The method of claim 1, further comprising:
storing a plurality of said locations determined for the mobile wireless device for each of a plurality of said created objects in a moving picture sequence, said locations being stored in association with respective ones of said created objects.

21. An apparatus, comprising:
an object creator in a wireless mobile device;
a wireless transceiver in the wireless mobile device;
a processor in the wireless mobile device;
a memory in the wireless mobile device coupled to said object creator, said transceiver, and said processor, programmed with instructions executable by said processor to perform the steps of:
creating an object with a mobile wireless device; and
determining a location of the mobile wireless device with respect to a plurality of wireless access points substantially when said creating occurs.

22. The apparatus of claim 21, where said determining step occurs after said creating step.

23. The apparatus of claim 21, where said determining step occurs before said creating step.

24. The apparatus of claim 21, further comprising:
said determining step including analyzing received signals from the plurality of access points to obtain a distance value from the wireless device to one or more of the plurality of access points.

25. The apparatus of claim 21, further comprising:
said determining step including calculating a relative position of the wireless device with respect to the plurality of access points.

26. The apparatus of claim 21, further comprising:
said determining step including accessing estimated positioning information of the plurality of wireless access point devices and combining a relative position of the wireless device with the estimated positioning information of the plurality to obtain an estimated position of the wireless device.

27. The apparatus of claim 21, further comprising:
said determining step including performing a calculation based on received signal strengths from said access points.

28. The apparatus of claim 21, further comprising:
said determining step including performing triangulation based on direction of receiving signals from said access points.

29. The apparatus of claim 21, further comprising:
said determining step including performing triangulation based on both direction and signal strength of signals received from said access points.

30. The apparatus of claim 21, further comprising:
said determining step including performing pattern recognition of received signals from said access points by comparing the received pattern with stored patterns associated with known locations.

31. The apparatus of claim 21, further comprising:
said memory further programmed with instructions executable by said processor to perform the step of:
storing said location determined for the mobile wireless device in association with said created object.

32. The apparatus of claim 21, further comprising:
said memory further programmed with instructions executable by said processor to perform the step of:
storing said location determined for the mobile wireless device as metadata embedded in said created object.

33. The apparatus of claim 21, further comprising:
said memory further programmed with instructions executable by said processor to perform the step of:
displaying said location determined for the mobile wireless device in association with displaying said created object.

34. The apparatus of claim 21, further comprising:
said memory further programmed with instructions executable by said processor to perform the steps of:
storing said location determined for the mobile wireless device separately from, but associated with said created object; and
embedding at a later time said location determined for the mobile wireless device as metadata embedded in said created object.

35. The apparatus of claim 21, further comprising:
said memory further programmed with instructions executable by said processor to perform the steps of:
transmitting to a destination said location determined for the mobile wireless device separately from said created object; and
embedding at said destination said location determined for the mobile wireless device as metadata embedded in said created object.

36. The apparatus of claim 21, further comprising:
said mobile wireless device using a wireless protocol drawn from the group consisting of Bluetooth, IEEE 802.15, IEEE 802.11, Hiperlan, WiMedia Ultra Wide Band (UWB), WiMax, WiFi, Digital Enhanced Cordless Telecommunications (DECT), Global System for Mobile (GSM), General Packet Radio Service (GPRS), Enhanced Data rates for GSM Evolution (EDGE), Code Division Multiple Access (CDMA), Universal Mobile Telecommunications System (UMTS) and CDMA2000.

37. The apparatus of claim 21, further comprising:
said mobile wireless device being a device drawn from the group consisting of a PDA, cell phone, pager, laptop computer, and palmtop computer.

38. The apparatus of claim 21, further comprising:
said created an object representing a still photograph.

39. The apparatus of claim 21, further comprising:
said created an object representing a moving picture sequence.

40. The apparatus of claim 21, further comprising:
said memory further programmed with instructions executable by said processor to perform the step of:
storing a plurality of said locations determined for the mobile wireless device for each of a plurality of said created objects in a moving picture sequence, said locations being stored in association with respective ones of said created objects.

41. A computer program product, comprising:
a computer readable medium storing program code which, when executed by a processor, performs the steps of:
creating an object with a mobile wireless device; and
determining a location of the mobile wireless device with respect to a plurality of wireless access points substantially when said creating occurs.

42. The computer program product of claim 41, where said determining step occurs after said creating step.

43. The computer program product of claim 41, where said determining step occurs before said creating step.

44. The computer program product of claim 41, further comprising:
said determining step including analyzing received signals from the plurality of access points to obtain a distance value from the wireless device to one or more of the plurality of access points.

45. The computer program product of claim 41, further comprising:
said determining step including calculating a relative position of the wireless device with respect to the plurality of access points.

46. The computer program product of claim 41, further comprising:
said determining step including accessing estimated positioning information of the plurality of wireless access point devices and combining a relative position of the wireless device with the estimated positioning information of the plurality to obtain an estimated position of the wireless device.

47. The computer program product of claim 41, further comprising:
said determining step including performing a calculation based on received signal strengths from said access points.

48. The computer program product of claim 41, further comprising:
said determining step including performing triangulation based on direction of receiving signals from said access points.

49. The computer program product of claim 41, further comprising:
said determining step including performing triangulation based on both direction and signal strength of signals received from said access points.

50. The computer program product of claim 41, further comprising:
said determining step including performing pattern recognition of received signals from said access points by comparing the received pattern with stored patterns associated with known locations.

51. The computer program product of claim 41, further comprising:
said computer readable medium further storing program code which, when executed by a processor, performs the step of:
storing said location determined for the mobile wireless device in association with said created object.

52. The computer program product of claim 41, further comprising:
said computer readable medium further storing program code which, when executed by a processor, performs the step of:
storing said location determined for the mobile wireless device as metadata embedded in said created object.

53. The computer program product of claim 41, further comprising:
displaying said location determined for the mobile wireless device in association with displaying said created object.

54. The computer program product of claim 41, further comprising:
said computer readable medium further storing program code which, when executed by a processor, performs the steps of:
storing said location determined for the mobile wireless device separately from, but associated with said created object; and
embedding at a later time said location determined for the mobile wireless device as metadata embedded in said created object.

55. The computer program product of claim 41, further comprising:
said computer readable medium further storing program code which, when executed by a processor, performs the steps of:
transmitting to a destination said location determined for the mobile wireless device separately from said created object; and
embedding at said destination said location determined for the mobile wireless device as metadata embedded in said created object.

56. The computer program product of claim 41, further comprising:
said mobile wireless device using a wireless protocol drawn from the group consisting of Bluetooth, IEEE 802.15, IEEE 802.11, Hiperlan, WiMedia Ultra Wide Band (UWB), WiMax, WiFi, Digital Enhanced Cordless Telecommunications (DECT), Global System for Mobile (GSM), General Packet Radio Service (GPRS), Enhanced Data rates for GSM Evolution (EDGE), Code Division Multiple Access (CDMA), Universal Mobile Telecommunications System (UMTS) and CDMA2000.

57. The computer program product of claim 41, further comprising:
said mobile wireless device being a device drawn from the group consisting of a PDA, cell phone, pager, laptop computer, and palmtop computer.

58. The computer program product of claim 41, further comprising:
said created an object representing a still photograph.

59. The computer program product of claim 41, further comprising:
said created an object representing a moving picture sequence.

60. The computer program product of claim 41, further comprising:
said computer readable medium further storing program code which, when executed by a processor, performs the step of:
storing a plurality of said locations determined for the mobile wireless device for each of a plurality of said created objects in a moving picture sequence, said locations being stored in association with respective ones of said created objects.

61. An apparatus, comprising:
means for creating an object with a mobile wireless device; and
means for determining a location of the mobile wireless device with respect to a plurality of wireless access points substantially when said creating occurs.
